(19) United States
(12) Patent Application Publication
(10) Pub. No.: US 2010/0093484 A1
(43) Pub. Date: Apr. 15, 2010

(54) POWER TRANSMISSION DEVICE

(76) Inventors: Guang-Miao Huang, Kaohsiung City (TW); Guo-Jhih Yan, Kaohsiung City (TW); Hsin-Te Wang, Taipei County (TW)

Correspondence Address: Muncy, Geissler, Olds & Lowe, PLLC, P.O. BOX 1364, FAIRFAX, VA, 22038-1364, US

(21) Appl. No.: 12/344,945

(22) Filed: Dec. 29, 2008

(30) Foreign Application Priority Data
Oct. 13, 2008 (TW) 097139148

(51) Int. Cl. F16H 37/06

(52) U.S. Cl. 475/330

(57) ABSTRACT

A power transmission device is provided. The power transmission device includes a motor, an intermediate gearset, and a planetary gearset assembly. The motor includes a motor output shaft. The intermediate gearset has an input gear connected to the motor output shaft. The motor drives an intermediate gear output shaft of an output gear of the intermediate gearset. The planetary gearset assembly has an input end connected to the intermediate gear output shaft. The intermediate gear output shaft drives a planetary gear output shaft of an output end of the planetary gearset assembly.

### CROSS REFERENCE TO RELATED APPLICATION

This application claims the benefit of Taiwan Patent Application No. 097139148, filed on Oct. 13, 2008, which is hereby incorporated by reference for all purposes as if fully set forth herein.

### BACKGROUND OF THE INVENTION

1. Field of the Invention

The present invention relates to a power transmission device, and more particularly to a power transmission device formed by a motor and gearsets within a limited space.

2. Related Art

In the prior art, a power transmission device generally uses a motor and gearsets to adjust a rotation speed and a torque. In practice, the gearsets that are often used in a conventional power transmission device are approximately classified into two types, one type is the intermediate gearset, and the other type is the planetary gearset. However, when being applied to structures such as robots, manipulators, electronic pets, remote control toys, or 3C electronic products, in order to save the space, the miniature design of the gearset must be considered. In this case, the intermediate gearset is seldom used, because it occupies more space for the same reduction ratio and is difficult to implement the miniature design. In contrast, the planetary gearset is mostly assembled with the motor to form the power transmission device.

Referring to FIG. 1, a conventional power transmission device 1 includes a motor 10 and a planetary gearset assembly 20. As shown in FIG. 1, the motor 10 has a motor output shaft 11, and the planetary gearset assembly 20 is formed by a plurality of planetary gearsets 21 connected in series. Each of the planetary gearsets 21 is formed by a drive arm 211, a plurality of planetary gears 212, and a plurality of planetary shafts 213. The drive arm 211 may be disposed with a sun gear 2111 or a gear output shaft 22, and each of the planetary gears 212 is engaged with the internal gear 23. In FIG. 1, the motor output shaft 11 of the motor 10 drives a linkage gear 12, and then the linkage gear 12 further drives the planetary gear 212 engaged therewith. Then, each of the planetary gears 212 drives the drive arm 211 through a planetary shaft 213 inserted in the respective planetary gear 212. The drive arm 211 has a mandrel 214. The drive arm 211 may use the sun gear 2111 to drive the planetary gear 212 in the next-stage planetary gearset 21, and so forth. Thus, a gear output shaft 22 disposed on the frontmost drive arm 211 is driven, so as to output the power. Generally, the planetary gearset assembly 20 functions to reduce the motor speed and increase the output torque.

The conventional planetary gearset assembly 20 is formed by a plurality of planetary gearsets 21 connected in series. When more planetary gearsets 21 are used, the planetary gearset assembly 20 becomes more difficult to be assembled, and it further difficult to guarantee the concentricity of the planetary gearsets 21, which often results in an unsmooth operation, and great noises, and what's worse, startup failure may even occur. In addition, in the conventional power transmission device 1, the planetary gearset assembly 20 and the motor output shaft 11 must be concentrically connected. In certain applications requiring a limited length, the length and the reduction ratio of the entire power transmission device 1 must be modified, which causes difficulties in both design and production. The above defects should be eliminated.

### SUMMARY OF THE INVENTION

Accordingly, the present invention is directed to a power transmission device, which is more convenient to be assembled, and has a higher concentricity.

The present invention is also directed to a power transmission device, which can maintain a high reduction ratio under a limited length.

In order to achieve the above objectives, a power transmission device is provided in the present invention, which includes a first motor, a first intermediate gearset, and a first planetary gearset assembly. The first motor has a motor output shaft. The first intermediate gearset has a first input gear connected to the motor output shaft. The first motor drives a first intermediate gear output shaft of a first output gear of the first intermediate gearset. The first planetary gearset assembly has an input end connected to the first intermediate gear output shaft. The first intermediate gear output shaft drives a planetary gear output shaft of an output end of the first planetary gearset assembly. To sum up, the power transmission device of the present invention uses the intermediate gearset to transmit a power of the motor output shaft to the planetary gearset assembly. Thus, the motor and the planetary gearset assembly may be stacked on each other or configured into other various arrangements. Compared with the prior art that is limited by the same mandrel, in the case that the lengthwise space is insufficient, the present invention can achieve structural configurations without sacrificing the reduction ratio, which enables the power transmission device to be designed into different modes through utilizing different configurations of the intermediate gearset. Therefore, the present invention can improve the reduction ratio and the torque within a limited space.

### BRIEF DESCRIPTION OF THE DRAWINGS

The present invention will become more fully understood from the detailed description given herein below for illustration only, and thus is not limitative of the present invention, and wherein:

FIG. 1 is a schematic view of a power transmission device in the prior art;

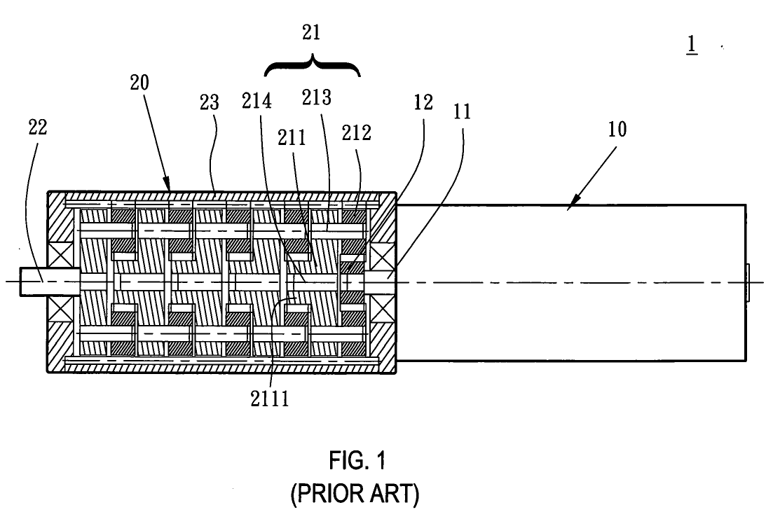

FIGS. 2A and 2B are respectively a schematic cross-sectional view and a schematic side view of a power transmission device according to a first embodiment of the present invention;

FIGS. 3A and 3B are respectively a schematic cross-sectional view and a schematic side view of a power transmission device according to a second embodiment of the present invention;

FIGS. 4A and 4B are respectively a schematic cross-sectional view and a schematic side view of a power transmission device according to a third embodiment of the present invention;

FIGS. 5A and 5B are respectively a schematic cross-sectional view and a schematic side view of a power transmission device according to a fourth embodiment of the present invention;

FIGS. 6A and 6B are respectively a schematic cross-sectional view and a schematic side view of a power transmission device according to a fifth embodiment of the present invention; and

FIGS. 7A and 7B are respectively a schematic cross-sectional view and a schematic side view of a power transmission device according to a sixth embodiment of the present invention.

### DETAILED DESCRIPTION OF THE INVENTION

A power transmission device according to embodiments of the present invention will be described below with reference to the accompanying drawings. In the accompanying drawings, as for the secondary figure numbers A and B followed the main figure numbers, A indicates a cross-sectional view of a power transmission device, and B indicates a side view of the power transmission device.

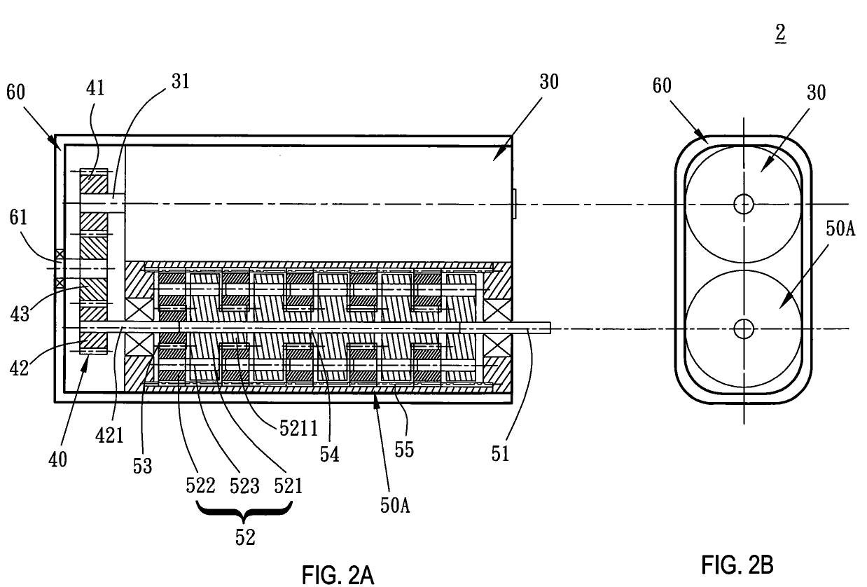

FIGS. 2A and 2B are schematic views of a first embodiment of the present invention. A power transmission device 2 in this embodiment includes a first motor 30, a first intermediate gearset 40, and a first planetary gearset assembly 50A. The first motor 30 has a first motor output shaft 31. The first intermediate gearset 40 has a first input gear 41 connected to the first motor output shaft 31. The first motor 30 drives a first intermediate gear output shaft 421 of a first output gear 42 of the first intermediate gearset 40. The first planetary gearset assembly 50A has an input end connected to the first intermediate gear output shaft 421. The first intermediate gear output shaft 421 drives a planetary gear output shaft 51 of an output end of the first planetary gearset assembly 50A.

In this embodiment, the power transmission device 2 is disposed within a casing 60, and a transmission shaft 61 is disposed on the casing 60.

The first intermediate gearset 40 further includes a first idle gear 43. The first input gear 41 links up with the first output gear 42 through the first idle gear 43. The first idle gear 43 is connected to the transmission shaft 61 on the casing 60.

The first planetary gearset assembly 50A is formed by a plurality of serially-connected planetary gearsets 52 engaged in an internal gear 55. Each of the planetary gearsets 52 is formed by a drive arm 521, a plurality of planetary gears 522, and a plurality of planetary shafts 523. The drive arm 521 may be provided with a sun gear 5211 or a planetary gear output shaft 51. Each of the planetary gearsets 52 is engaged with the internal gear 55 through the corresponding planetary gears 522. Moreover, a transmission gear 53 is further disposed on the input end of the first planetary gearset assembly 50A, so as to be connected to the first intermediate gear output shaft 421. As shown in FIGS. 2A and 2B, the first intermediate gear output shaft 421 drives the surrounding planetary gears 522 through the transmission gear 53, and then the planetary gears 522 drives the drive arm 521 through the planetary shafts 523 fastened with the driven arm 521. A gap exists between the planetary shafts 523 and the planetary gears 522, such that the planetary gears 522 may rotate relative to the planetary shafts 523. Then, the sun gear 5211 disposed on the drive arm 521 drives the next-stage planetary gears 522. A mandrel 54 passes through the drive arms 521, and connects the drive arms 521 in series. A gap exists between the mandrel 54 and the drive arms 521, such that the drive arms 521 can rotate about the mandrel 54 concentrically. Thus, the concentricity of the drive arms 521 is improved, and the plurality of planetary gearsets 52 can be assembled conveniently. When the drive arm 521 located at the output end of the first planetary gearset assembly 50A is similarly driven stage by stage, the planetary gear output shaft 51 assembled on the drive arm 521 is also driven. According to products commercially available on the market, the five-stage first planetary gearset assembly 50A may achieve a reduction ratio of 854:1.

In the embodiment shown in FIG. 2, the first motor output shaft 31 and the planetary gear output shaft 51 rotate towards the same direction. If the rotating direction of the planetary gear output shaft 51 needs to be changed, the transmission shaft 61 and the first idle gear 43 may be omitted, or another transmission shaft 61 and a first idle gear 43 may be added, which are engaged with each other by using an appropriate first input gear 41 and an appropriate first output gear 42, thereby changing the rotating direction of the planetary gear output shaft 51.

It should be noted that, in this embodiment, the first motor 30 and the first planetary gearset assembly 50A are stacked on each other. As shown in FIGS. 2A and 2B, the first motor 30 is disposed in an upper part of the casing 60, and the first planetary gearset assembly 50A is disposed in a lower part of the casing 60. However, the positions of the first motor 30 and the first planetary gearset assembly 50A may be exchanged depending upon the actual requirements, which should be deemed as a technical variation that can be easily thought of.

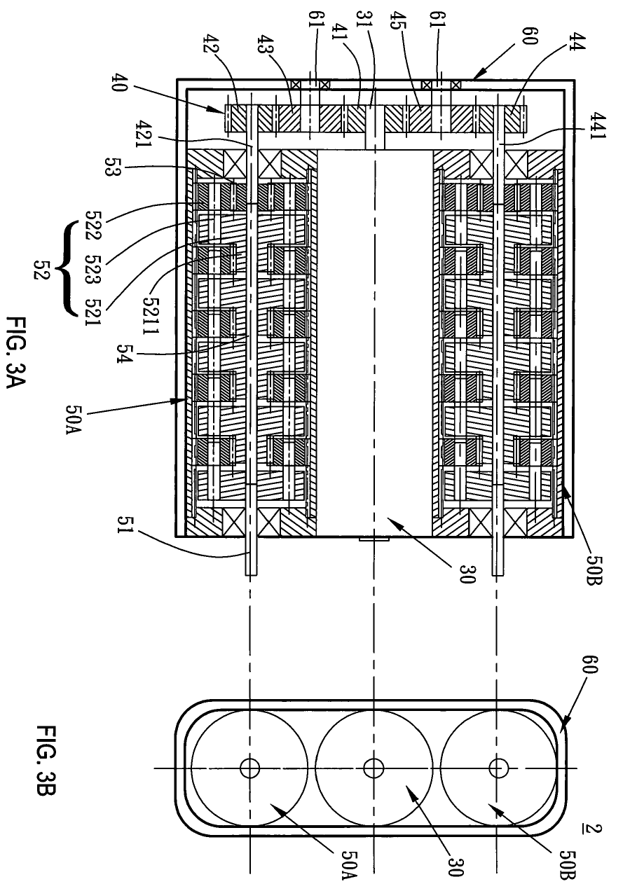

FIGS. 3A and 3B are schematic views of a second embodiment of the present invention. Compared with the first embodiment, in this embodiment, a second planetary gearset assembly 50B is added on the first motor 30, so that a corresponding second output gear 44 is added to the first intermediate gearset 40, and a second intermediate gear output shaft 441 is disposed on the second output gear 44 to drive the second planetary gearset assembly 50B.

Certainly, the first intermediate gearset 40 is further disposed with a second idle gear 45 between the first input gear 41 and the second output gear 44, and the second idle gear 45 is connected to a transmission shaft 61 on the casing 60. The first input gear 41 links up with the second output gear 44 through the second idle gear 45.

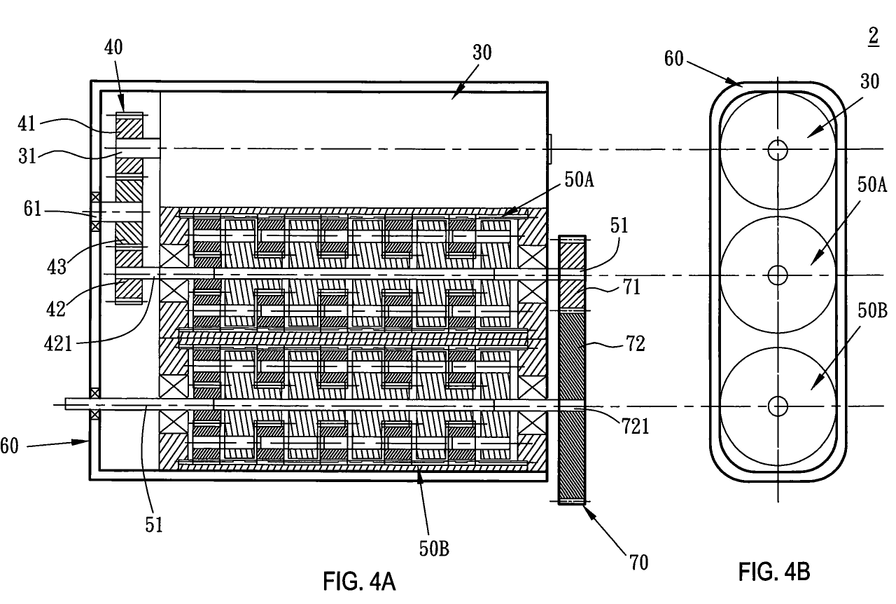

FIGS. 4A and 4B are schematic views of a third embodiment of the present invention. Compared with the first embodiment, in this embodiment, a second intermediate gearset 70 and a second planetary gearset assembly 50B are added. The added second planetary gearset assembly 50B is disposed in the lowest part of the casing 60. The second intermediate gearset 70 has a third input gear 71 and a third output gear 72. The third input gear 71 is connected to the planetary gear output shaft 51 of the first planetary gearset assembly 50A, so as to link up with the third output gear 72. In addition, the third output gear 72 is further disposed with a second intermediate gear output shaft 721, so as to link up with the second planetary gearset assembly 50B and the second planetary gear output shaft 51.

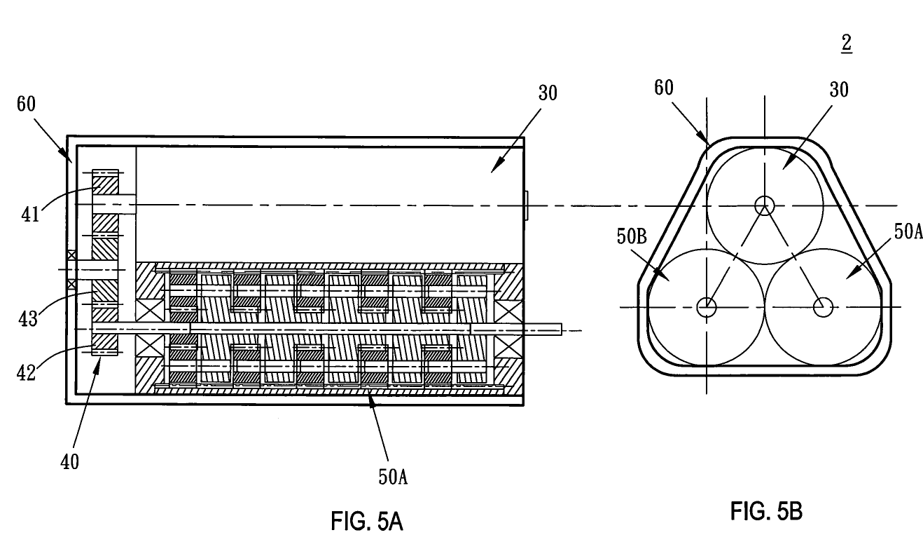

FIGS. 5A and 5B are schematic views of a fourth embodiment of the present invention. This embodiment is similar to a combination of the first and second embodiments, but the difference lies in that, in this embodiment, the first planetary gearset assembly 50A and the second planetary gearset assembly 50B are arranged transversely side by side, and the first motor 30 is stacked on the first planetary gearset assembly 50A and the second planetary gearset assembly 50B.

In addition, in this embodiment, the first intermediate gearset 40 is disposed with two first output gears 42, which are driven by the first idle gear 43 after the first idle gear 43 is driven by the first input gear 41. Then, the two first output gears 42 respectively drive the first planetary gearset assembly 50A and the second planetary gearset assembly 50B.

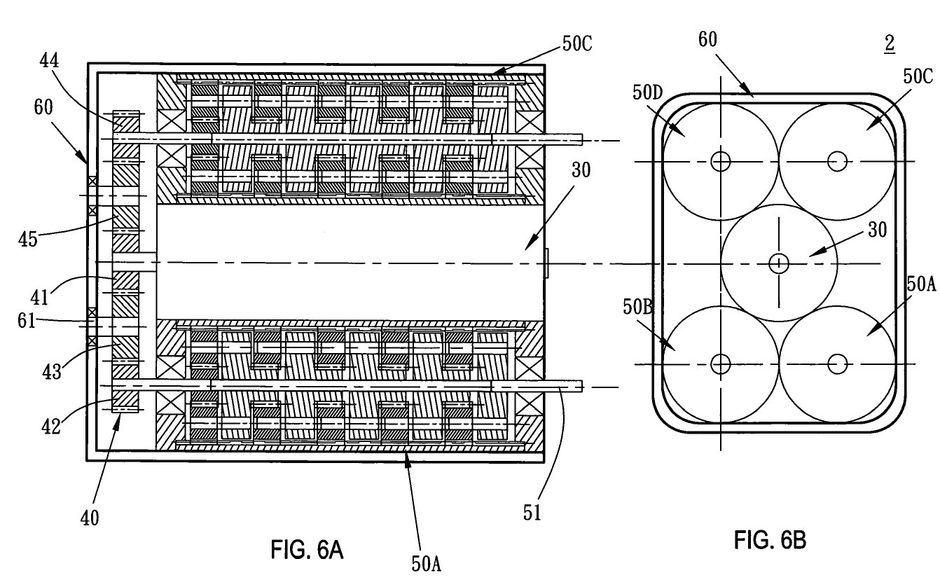

FIGS. 6A and 6B are schematic views of a fifth embodiment of the present invention. This embodiment is similar to a combination of the second and fourth embodiments, but the difference lies in that, this embodiment further includes a third planetary gearset assembly 50C and a fourth planetary gearset assembly 50D, which are arranged transversely side by side, and are stacked on the first motor 30. In order to cater to this configuration, the first intermediate gearset 40 includes two first output gears 42 and two second output gears 44. After the first input gear 41 drives the first idle gear 43 and the second idle gear 45, the first idle gear 43 drives the two first output gears 42, and the second idle gear 45 drives the two second output gears 44. Then, the two first output gears 42 respectively link up with the first planetary gearset assembly 50A and the second planetary gearset assembly 50B, and the two second output gears 44 respectively link up with the third planetary gearset assembly 50C and the fourth gearset assembly 50D.

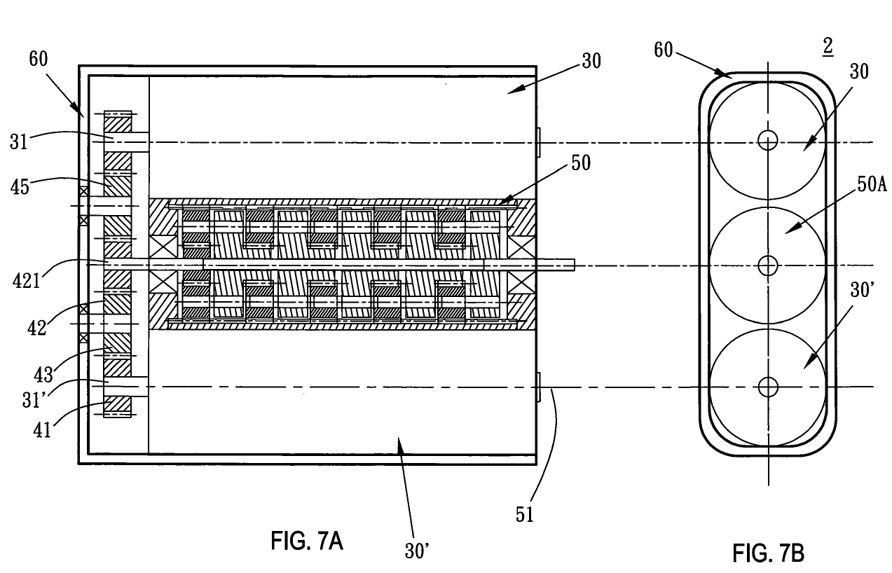

FIGS. 7A and 7B are schematic views of a sixth embodiment of the present invention. This embodiment is similar to the second embodiment, but the difference lies in that, this embodiment is further added with a second motor 30′, instead of the second planetary gearset assembly 50B in the second embodiment. In this embodiment, the first planetary gearset assembly 50A is sandwiched between the first motor 30 and the second motor 30′. In this embodiment, the positions of the first motor 30 and the first planetary gearset assembly 50A are reversed with respect to the positions thereof in the first embodiment. Therefore, in this embodiment, the first input gear 41 of the first intermediate gearset 40 is driven by the first motor 30, and the first output gear 42 is driven by the first idle gear 43, and the first intermediate gear output shaft 421 links up with the first planetary gearset assembly 50A. In addition, this embodiment is further added with the second motor 30′, which has a second motor output shaft 31′ connected to a second input gear 46 of the first intermediate gearset 40, and the first output gear 42 may be driven by the second idle gear 45. Thus, in this embodiment, the first planetary gearset assembly 50A is driven by the two motors 30 and 30′ at the same time.

It should be noted that, in FIGS. 7A and 7B, the first motor 30 and the second motor 30′ may be arranged together with the first planetary gearset assembly 50A with reference to the arrangements shown in FIGS. 5A and 5B and FIGS. 6A and 6B. That is, the first motor 30 and the second motor 30′ are arranged transversely side by side, and the first planetary gearset assembly 50A is stacked on the second motor 30′; or a third motor (not shown) and a fourth motor (not shown) arranged transversely side by side may be further added and stacked on the first planetary gearset assembly 50A, the first motor 30, and the second motor 30′.

The power transmission device of the present invention uses the intermediate gearset to transmit a power of the motor output shaft to the planetary gearset assembly. Thus, the motor and the planetary gearset assembly may be stacked on each other or configured into other various arrangements. Compared with the prior art that is limited by the same mandrel, in the case that the lengthwise space is insufficient, the present invention can achieve structural configurations without sacrificing the reduction ratio, which enables the entire power transmission device to be designed into different modes through utilizing different configurations of the intermediate gearset. Therefore, the present invention can improve the reduction ratio and the torque within a limited space.

The above descriptions are only illustrative, but not intended to limit the present invention. Various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A power transmission device, comprising:
a first motor, having a motor output shaft;
a first intermediate gearset, having a first input gear connected to the motor output shaft, wherein the first motor drives a first intermediate gear output shaft of a first output gear of the first intermediate gearset; and
a first planetary gearset assembly, having an input end connected to the first intermediate gear output shaft, wherein the first intermediate gear output shaft drives a planetary gear output shaft of an output end of the first planetary gearset assembly.

2. The power transmission device according to claim 1, wherein the power transmission device is disposed within a casing.

3. The power transmission device according to claim 2, wherein the first intermediate gearset further comprises a first idle gear, the first input gear links up with the first output gear through the first idle gear, and the first idle gear is connected to a transmission shaft on the casing.

4. The power transmission device according to claim 1, wherein the first planetary gearset assembly is formed by a plurality of planetary gearsets connected in series, each of the planetary gearsets comprises a drive arm, a plurality of planetary gears, and a plurality of planetary shafts, and when the planetary gears are driven, the planetary shafts link up with the drive arm.

5. The power transmission device according to claim 4, wherein the planetary gears of the planetary gearsets are engaged in an internal gear.

6. The power transmission device according to claim 4, wherein a mandrel passes through the drive arms of the planetary gearsets.

7. The power transmission device according to claim 4, wherein the planetary gears located at the input end of the first planetary gearset assembly are driven by a transmission gear disposed on the first intermediate gear output shaft, and the rest planetary gears are driven by a sun gear disposed on a previous-stage drive arm.

8. The power transmission device according to claim 4, wherein the planetary gear output shaft is disposed on the drive arm of the output end of the first planetary gearset assembly.

9. The power transmission device according to claim 1, wherein the first motor and the first planetary gearset assembly are stacked on each other.

10. The power transmission device according to claim 1, further comprising a second planetary gearset assembly, wherein the first intermediate gearset further comprises a second output gear, and the second output gear has a second intermediate gear output shaft for driving the second planetary gearset assembly.

11. The power transmission device according to claim 10, wherein the power transmission device is disposed within a casing, the first intermediate gearset further comprises a second idle gear, the first input gear links up with the second output gear through the second idle gear, and the second idle gear is connected to a transmission shaft on the casing.

12. The power transmission device according to claim 10, wherein the first motor, the first planetary gearset assembly, and the second planetary gearset assembly are stacked on each other.

13. The power transmission device according to claim 10, wherein the first planetary gearset assembly and the second planetary gearset assembly are arranged transversely side by side, and the first motor is stacked on the first planetary gearset assembly and the second planetary gearset assembly.

14. The power transmission device according to claim 13, further comprising a third planetary gearset assembly and a fourth planetary gearset assembly arranged transversely side by side and stacked on the first motor.

15. The power transmission device according to claim 14, wherein the first intermediate gearset further comprises a plurality of output gears, and each of the plurality of output gears is disposed with an intermediate gear output shaft to drive the third planetary gearset assembly and the fourth planetary gearset assembly.

16. The power transmission device according to claim 1, further comprising a second intermediate gearset and a second planetary gearset assembly, wherein the second intermediate gearset is driven by the first planetary gearset assembly, so as to link up with the second planetary gearset assembly.

17. The power transmission device according to claim 16, wherein the first motor, the first planetary gearset assembly, and the second planetary gearset assembly are stacked on each other.

18. The power transmission device according to claim 16, wherein the second intermediate gearset has a third input gear and a third output gear, the third input gear is connected to the planetary gear output shaft of the first planetary gearset assembly, links up with the third output gear, and drives a second intermediate gear output shaft of the third output gear.

19. The power transmission device according to claim 1, further comprising a second motor, wherein the second motor comprises a second motor output shaft, and the first intermediate gearset further comprises a second input gear connected to the second motor output shaft, such that the first planetary gearset assembly is driven by the first motor and the second motor at a same time.

20. The power transmission device according to claim 19, wherein the second input gear links up with the first output gear through a second idle gear.

21. The power transmission device according to claim 20, wherein the power transmission device is disposed within a casing and the second idle gear is connected to a transmission shaft on the casing.

22. The power transmission device according to claim 19, wherein the first motor, the second motor, and the first planetary gearset assembly are stacked on each other.

23. The power transmission device according to claim 19, wherein the first motor and the second motor are arranged transversely side by side, and the first planetary gearset assembly is stacked on the first motor and the second motor.

24. The power transmission device according to claim 23, further comprising a third motor and a fourth motor arranged transversely side by side and stacked on the first planetary gearset assembly.
